(19) United States
(12) Patent Application Publication
(10) Pub. No.: US 2026/0244492 A1
(43) Pub. Date: Aug. 20, 2026

(54) COMPUTER-READABLE RECORDING MEDIUM HAVING STORED THEREIN OPERATION FREQUENCY CHANGING PROGRAM, OPERATION FREQUENCY CHANGING METHOD, AND INFORMATION PROCESSING APPARATUS

(71) Applicant: 1FINITY Inc., Kawasaki-shi (JP)

(72) Inventor: Ken IIZAWA, Kawasaki (JP)

(73) Assignee: 1FINITY Inc., Kawasaki-shi (JP)

(21) Appl. No.: 19/542,318

(22) Filed: Feb. 17, 2026

(30) Foreign Application Priority Data
Feb. 18, 2025 (JP) 2025-024145

(51) Int. Cl. G06F 9/48

(52) U.S. Cl. CPC G06F 9/4881

(57) ABSTRACT

A computer-readable recording medium having stored therein an operation frequency changing program that causes a computer to execute a changing process including: grouping a plurality of processes to be executed by a plurality of first accelerators in accordance with usage rates of calculation resources that partitions to which each process has been allocated have; for each of grouped groups, moving a plurality of processes included in the group to a second accelerator associated with the group; and lowering an operation frequency of each of a plurality of the second accelerators.

### CROSS-REFERENCE TO RELATED APPLICATION

This application is based upon and claims the benefit of priority of the prior Japanese Patent application No. 2025-024145, filed on February 18, 2025, the entire contents of which are incorporated herein by reference.

### FIELD

The present embodiments relate to a computer-readable recording medium having stored therein an operation frequency changing program, an operation frequency changing method, and an information processing apparatus.

### BACKGROUND

In recent years, scenes where a large amount of data is processed at a high speed, such as machine learning processing and inference processing in artificial intelligence (AI) technologies, big data analysis processing, and the like, have increased. For such workloads, accelerators such as graphics processing units (GPUs) may be used in order to realize higher-performance and more efficient calculation than central processing units (CPUs). Hereinafter, the accelerators may be referred to as ACCs. Note that the ACCs may include cards (accelerator cards) having an accelerator operation function.

For example, related arts are disclosed in Japanese Laid-open Patent Publication No. 2012-150668, Japanese National Publication of International Patent Application No. 2014-527227 and Japanese National Publication of International Patent Application No. 2014-535089.

### SUMMARY

According to an aspect of the embodiment, a computer-readable recording medium having stored therein an operation frequency changing program that causes a computer to execute a changing process including: grouping a plurality of processes to be executed by a plurality of first accelerators in accordance with usage rates of calculation resources that partitions to which each process has been allocated have; for each of grouped groups, moving a plurality of processes included in the group to a second accelerator associated with the group; and lowering an operation frequency of each of a plurality of the second accelerators.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating a configuration example of a system as an example of an embodiment;

FIG. 2 is a block diagram illustrating a hardware configuration of a computer according to an embodiment;

FIG. 3 is a block diagram illustrating a functional configuration example of a server according to an embodiment;

FIG. 4 is a diagram illustrating an example of workload management information;

FIG. 5 is a diagram illustrating an example of ACC management information;

FIG. 6 is a diagram for explaining an example of an ACC usage rate;

FIG. 7 is a diagram illustrating a calculation example of a calculation resource amount to be allocated to a workload;

FIG. 8 is a diagram illustrating an example of partition management information;

FIG. 9 is a diagram illustrating an example of a usage rate for each partition;

FIG. 10 is a diagram illustrating an example of partition usage rate information;

FIG. 11 is a diagram for explaining an example of processing performed by a reallocating unit;

FIG. 12 is a flowchart for explaining an operation example of a system according to an embodiment; and

FIG. 13 is a flowchart for explaining an operation example of reallocation processing according to an embodiment.

### DESCRIPTION OF EMBODIMENTS

ACCs may be designed to have the highest power efficiency (for example, performance per power consumption) when they are running at their full capacity. Therefore, in processing in which the usage rate of the ACCs is relatively low among processes (applications) using the ACCs, such as inference processing, power efficiency of the ACCs may decrease.

For example, it is possible to increase the usage rate of the ACCs to some extent by a technique of dividing calculation resources (hardware resources) of the ACCs and allocating the calculation resources to a workload in divided units. However, there is still room for improvement from the viewpoint of improving the power efficiency of the ACCs, for example, reduction of power consumption.

Hereinafter, the present embodiments will be described with reference to the drawings. However, the embodiments described below are merely examples, and there is no intention to exclude applications of various modifications and techniques that are not explicitly described below. For example, it is possible to variously modify and implement the present embodiments without departing from the gist thereof. Note that, in the drawings used in the following description, portions denoted by the same reference numerals represent the same or similar portions unless otherwise particularly specified.

### [A] Description of System

A system according to an embodiment causes a server to execute AI processing using a plurality of ACCs, for example. In an embodiment, a technique in which the server divides calculation resources of the ACCs and allocates the calculation resources to the AI processing in divided units is assumed to be used, and at that time, a method for reducing power consumption while suppressing degradation of performance of the AI processing will be described.

### [A-1] Configuration Example of System

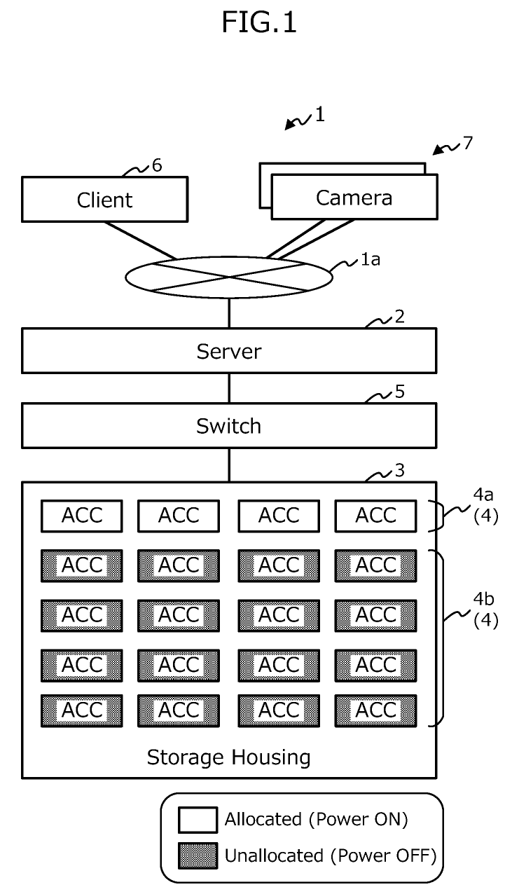

FIG. 1 is a block diagram illustrating a configuration example of a system 1 as an example of an embodiment; As illustrated in FIG. 1, the system 1 may include a server 2, a storage housing 3 that houses (stores) a plurality of ACCs 4, a switch 5, a client 6, and a plurality of cameras 7.

The system 1 is an example of an information processing system that causes the server 2 to execute processing using the ACCs 4 in the storage housing 3. In an embodiment, the system 1 causes the server 2 to execute various kinds of AI processing (for example, inference processing) on stream data transmitted from each of the plurality of cameras 7 to the server 2, for example. A result of the AI processing may be transmitted to the client 6, for example. Note that the system 1 may cause the server 2 to execute machine learning processing, big data analysis processing, or the like, instead of the inference processing.

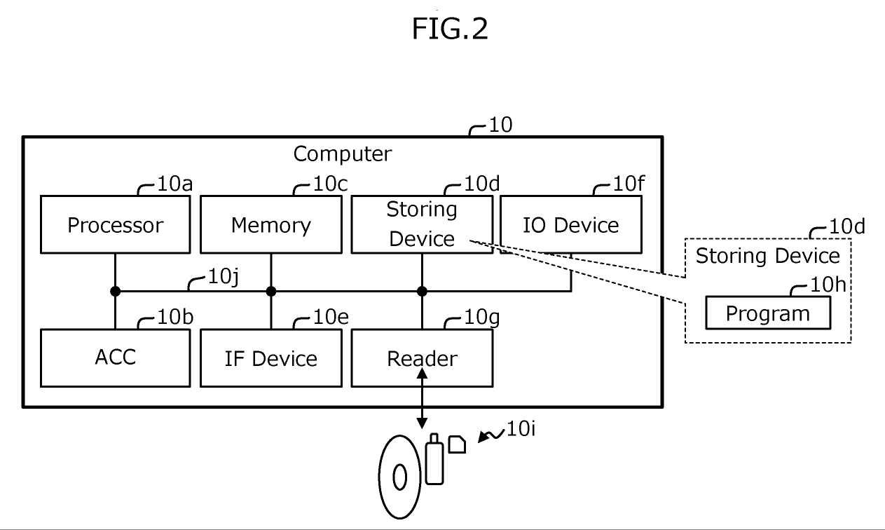

The server 2 is an example of an information processing apparatus or a computer. For example, the server 2 allocates calculation resources of the ACCs 4 in the storage housing 3 to the stream data received from each camera 7 and executes the AI processing on the stream data using the calculation resources. A HW configuration of the server 2 will be described later with reference to FIG. 2.

The storage housing 3 is an example of a housing capable of housing the plurality of (two or more) ACCs 4, and in the example in FIG. 1, twenty ACCs 4 are stored therein. The storage housing 3 may include a plurality of slots into and from which the ACCs 4 can be inserted and removed, for example, and may communicably connect the plurality of ACCs 4 to the server 2 via the slots and the switch 5. The storage housing 3 and the slots thereof may conform to various communication standards with which the ACCs 4 comply. In an embodiment, in a case where the ACCs 4 are peripheral component interconnect express (PCIe) devices that comply with the PCIe standard, the storage housing 3 may be a PCIe extended box including a plurality of slots that comply with the PCIe standard. In this case, the server 2 can use the ACCs 4 housed in the storage housing 3 as the PCIe devices by the storage housing 3 being connected to a PCIe slot in a server 2 main body via the switch 5.

The ACCs 4 are an example of processing execution devices or arithmetic processing devices, execute processing requested from the server 2, and transmit execution results to the server 2. As the ACCs 4, various devices such as GPUs, accelerated processing units (APUs), digital signal processors (DSPs), application specific integrated circuits (ASICs), and field-programmable gate arrays (FPGAs), for example, are exemplified. Although the ACCs 4 will be described as complying with the PCIe standard in an embodiment, the present disclosure is not limited thereto, and the ACCs 4 may comply with various other communication protocols such as NVLink^{®}.

The switch 5 connects the server 2 to the storage housing 3 including the ACCs 4 such that communication can be performed therebetween. The switch 5 may be, for example, a switch or an interconnect that complies with various communication schemes (bus architectures) corresponding to the standard with which the ACCs 4 comply, and in an embodiment, the switch 5 is a PCIe switch.

Note that at least either the storage housing 3 or the switch 5 may have a function of switching ON/OFF of a power supply for each ACC 4. The following description will be given on the assumption that the storage housing 3 has the function. Note that the ACCs 4 that are being used by the server 2 (being allocated to processing) may be referred to as ACCs 4a, and the ACCs 4 that are unavailable to the server 2 (not allocated to processing) may be referred to as ACCs 4b.

Once the controller (not illustrated) of the storage housing 3 receives an allocation instruction of the ACCs 4 from the server 2, for example, the controller switches (activates) the power supply of one ACC 4b to the ON state, and transmits identification information of the ACC 4b to the server 2. The server 2 can expand available ACCs 4a by allocating processing to the ACCs 4b (changing them to ACCs 4a) (see the ACCs 4a in the outlined frames in FIG. 1). On the other hand, once the controller of the storage housing 3 receives a return instruction of the ACCs 4b which have not been allocated from the server 2, for example, the controller switches the power supply of the ACCs 4b indicated by the return instruction to the OFF state (see the ACCs 4b in the shaded frames in FIG. 1) and issues a completion response. The server 2 manages the ACCs 4b as being in an unavailable (unassigned) state. Although the above-described processing performed by the storage housing 3 (or the switch 5) is executed in response to issuance of the allocation instruction or the return instruction in the following description as well, repeated description of the processing will be omitted.

The client 6 is an example of a computer, and is, for example, a user terminal used by a user of the system 1. The client 6 may be connected to the server 2 in an accessible manner via the network 1a including one or both of the Internet and a LAN, and may perform transmission of an allocation request, reception of an AI processing result, and the like as the access.

Each of the plurality of cameras 7 transmits stream data to the server 2 via the network 1a. Each piece of the stream data may include, for example, one or both of a video (a plurality of images, a moving image) obtained by imaging a specific imaging range and sound recorded (acquired) in the surroundings of a location where each camera 7 is installed. AI processing on the stream data is an example of a workload executed using the calculation resources of ACCs 4. Hereinafter, a workload may be referred to as a WL. A WL is an example of processing executed by the ACCs 4. Examples of target data of the WL (data available for the WL) include a plurality of pieces of data in which performance requirements (for example, a frame rate, a frame size, and the like) of each piece of data sequentially input to the ACCs 4 in a time series manner are constant or substantially constant on a time axis. In an embodiment, stream data is assumed to be used as target data of the WL.

### [A-2] Hardware Configuration Example of Server

The functions of the server 2 according to an embodiment may be realized by one computer or may be realized by two or more computers. Furthermore, at least some of the functions of the server 2 may be realized by using hardware (HW) resources and network (NW) resources provided by a cloud environment.

FIG. 2 is a block diagram illustrating a hardware configuration example of a computer 10 according to an embodiment. The computer 10 is an example of a computer that realizes the functions of the server 2. In a case where a plurality of computers are used as hardware resources that realize the functions of the server 2, each computer may include the HW configuration illustrated as an example in FIG. 2.

As illustrated in FIG. 2, the computer 10 may illustratively include a processor 10a, an accelerator 10b, a memory 10c, a storage unit 10d, an interface (IF) 10e, an input/output (IO) unit 10f, and a reading unit 10g as a HW configuration.

The processor 10a is an example of an arithmetic processing device that performs various kinds of control and arithmetic operations. The processor 10a may be communicably connected to each block in the computer 10 via a bus 10j. Note that the processor 10a may be a multiprocessor including a plurality of processors, may be a multi-core processor including a plurality of processor cores, or may have a configuration including a plurality of multi-core processors.

Examples of the processor 10a include an integrated circuit (IC) such as a CPU, a micro processing unit (MPU), an APU, a DSP, an ASIC, and an FPGA. Note that a combination of two or more of these integrated circuits may be used as the processor 10a.

The accelerator 10b is an arithmetic processing device that executes AI tasks such as machine learning processing and inference processing using a machine learning model and may be referred to as an AI accelerator. Note that the accelerator 10b may have a configuration as a graphics processing device (graphics accelerator) that performs screen display control on an output device such as a monitor in an IO unit 10f. Each of the ACCs 4 illustrated in FIG. 1 is an example of the accelerator 10b. For example, the accelerator 10b may be mounted on the computer 10, may be connected to the computer 10 via the storage housing 3 and the switch 5 like each ACC 4, or may adopt both aspects. Examples of the accelerator 10b include various arithmetic processing devices, for example, an integrated circuit (IC) such as a GPU, an APU, a DSP, an ASIC, and an FPGA.

The memory 10c stores information such as various kinds of data and programs. Examples of the memory 10c include one or both of a volatile memory such as a dynamic random access memory (DRAM) and a nonvolatile memory such as a persistent memory (PM).

The storage unit 10d stores information such as various kinds of data and programs. Examples of the storage unit 10d include various storage devices such as a magnetic disk device such as a hard disk drive (HDD), a semiconductor drive device such as a solid state drive (SSD), and a nonvolatile memory. Examples of the nonvolatile memory include a flash memory, a storage class memory (SCM), and a read only memory (ROM).

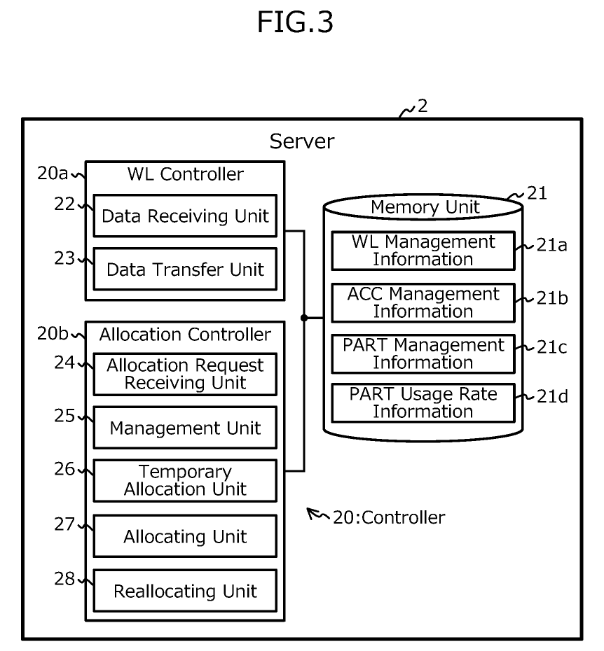

The storage unit 10d may store a program 10h (operation frequency changing program) that realizes all or some of various functions of the computer 10. For example, the processor 10a of the computer 10 can realize functions of the control unit 20 (see FIG. 3), which will be described later by loading a program 10h stored in the storage unit 10d into the memory 10c and executing the program 10h.

An IF unit 10e is an example of a communication IF that performs control and the like of connection and communication between the computer 10 and other computers. For example, the IF unit 10e may include any of various adapters conforming to PCIe, Ethernet ®, InfiniBand, or Millinet. The adapter may comply with one or both of wireless and wired communication systems. In addition, the adapter may conform to optical communication such as a fibre channel (FC), for example.

For example, the computer 10 may be communicably connected to each of the plurality of ACCs 4 (in the power-on state) in the storage housing 3 via the IF unit 10e, the switch 5, and the storage housing 3. Note that the program 10h may be downloaded from the network 1a to the computer 10 via the communication IF and may be stored in the storage unit 10d.

The IO unit 10f may include one or both of an input device and an output device. Examples of the input device include a keyboard, a mouse, and the like. Examples of the output device include a monitor, a projector, a printer, and the like. In addition, the IO unit 10f may include a touch panel or the like in which the input device and the output device are integrated. The output device may be connected to the accelerator 10b.

The reading unit 10g is an example of a reader that reads information, such as data and programs, recorded on the recording medium 10i. The reading unit 10g may include a connection terminal or device to which the recording medium 10i can be connected or inserted. Examples of the reading unit 10g include an adapter conforming to a universal serial bus (USB) or the like, a drive device that accesses a recording disk, and a card reader that accesses a flash memory such as an SD card. Note that the program 10h may be stored in the recording medium 10i, and the reading unit 10g may read the program 10h from the recording medium 10i and store the program 10h in the storage unit 10d.

Illustrative examples of the recording medium 10i include non-transitory computer-readable recording media such as a magnetic/optical disk and a flash memory. Illustrative examples of the magnetic/optical disk include a flexible disk, a compact disc (CD), a digital versatile disc (DVD), a Blu-ray disc, and a holographic versatile disc (HVD). Illustrative examples of the flash memory include semiconductor memories such as a USB memory and an SD card.

The above-described HW configuration of the computer 10 is an illustrative example. Therefore, HW in the computer 10 may be increased or decreased (for example, addition or deletion of optional blocks), divided, integrated in an optional combination, or buses may be added or deleted as appropriate.

[A-3] Functional Configuration Example of Server

FIG. 3 is a block diagram illustrating a functional configuration example of the server 2 according to an embodiment. As illustrated in FIG. 3, the server 2 may illustratively include a workload (WL) control unit 20a, an allocation control unit 20b, and a memory unit 21. The WL control unit 20a and the allocation control unit 20b are examples of the control unit 20.

The memory unit 21 is an example of a storage area and stores various kinds of data to be used by the server 2. The memory unit 21 may be realized by, for example, a storage area included in one or both of the memory 10c and the storage unit 10d (see FIG. 2) of the server 2.

As illustrated in FIG. 3, the memory unit 21 may be able to illustratively store workload (WL) management information 21a, ACC management information 21b, partition (PART) management information 21c, and PART usage rate information 21d. Although each of the pieces of information 21a to 21d will be described in a table format below, the present disclosure is not limited thereto, and each of the pieces of information 21a to 21d may be data in various formats such as a database (DB) or an array. Description of the information 21a to 21d will be given in description of each of functions that the WL control unit 20a and the allocation control unit 20b have.

The WL control unit 20a is adapted to mainly perform control related to a WL and may include a data receiving unit 22 and a data transfer unit 23.

The data receiving unit 22 receives a plurality of pieces of stream data to be input to a WL (for example, AI processing). The data receiving unit 22 may sequentially receive the stream data from each of the plurality of cameras 7 via, for example, the IF unit 10e and the network 1a. Note that in an embodiment, it is assumed that stream data received from one camera 7 is an input to one WL, and that the stream data (camera 7) and the WL are associated with each other one by one.

The data transfer unit 23 transfers the received stream data (hereinafter, it may be simply referred to as a “WL” from the above-described one-to-one relationship) to a corresponding ACC 4. For example, the data transfer unit 23 may refer to WL management information 21a to specify the ACC 4 to which the WL is allocated and transfer the WL to the specified ACC 4 via the IF unit 10e and the switch 5.

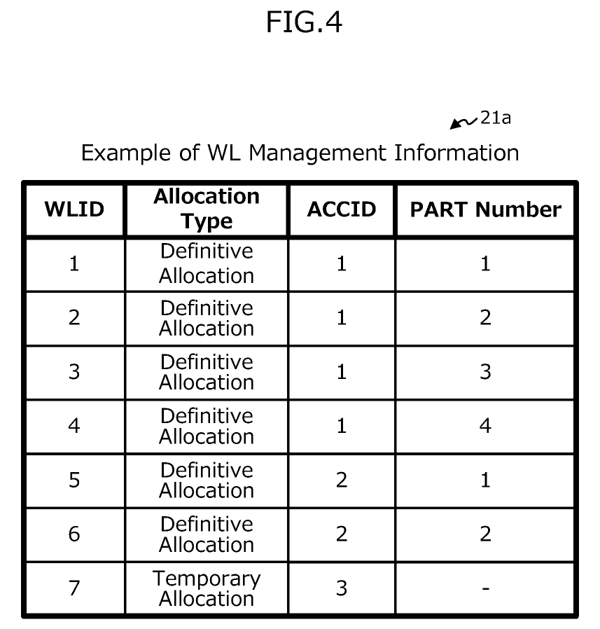

FIG. 4 is a diagram illustrating an example of the WL management information 21a. The WL management information 21a is information that records an ACC 4 and a partition allocated to each WL. The WL management information 21a may illustratively include items of WLID, an allocation type, ACCID, and a PART number. WLID is an example of identification information of each WL. The allocation type indicates a type of allocation between each WL and each ACC 4 and may include, for example, “definitive allocation” and “temporary allocation” as setting values. ACCID is an example of identification information of each ACC 4. The PART number is an example of identification information of each partition.

The “partition” is an example of a partial calculation resource (calculation processing unit) obtained by dividing calculation resources (hardware resources) of the ACCs 4. Examples of the calculation resources of the ACCs 4 include a plurality of (as an example, several hundreds to several tens of thousands or more) arithmetic cores and memories (for example, video random access memories (VRAMs)). The plurality of arithmetic cores can be logically divided into a plurality of (as an example, several to several tens or more) divided resources and can be managed and used. Storage areas of the memories can also be logically divided into a plurality of (as an example, several to several tens or more) divided resources and can be managed and used. In an embodiment, it is assumed that a combination of the divided resources of the arithmetic cores and the divided resources of the memories is an example of the partitions. Hereinafter, the partitions may be referred to as “PARTs”. Details of the partitions will be described later.

Each WL can be allocated to and executed by an entire ACC 4 (all of the arithmetic cores and all of the storage areas of the memories) (see the entry of WLID: 7 in FIG. 4). Moreover, each WL can also be allocated to a partition (some of the arithmetic cores and some of the storage areas of the memories) and can be executed (see the entries of WLID: 1 to 6 in FIG. 4). Note that in a case where the WL is allocated to the entire ACC 4 in the WL management information 21a, “-” is set as the PART number.

The data transfer unit 23 may refer to the WL management information 21a to specify the ACC 4 to which the WLID of the WL is allocated and the PART number (if any), and transfer the WL to the storage housing 3 by designating the specified ACC 4 (and the PART number) as a destination.

Returning to FIG. 3, the allocation control unit 20b may illustratively include an allocation request receiving unit 24, a management unit 25, a temporary allocation unit 26, an allocating unit 27, and a reallocating unit 28.

The allocation request receiving unit 24 receives a request for allocating an ACC 4 to a WL from the client 6 via the IF unit 10e and the network 1a. The allocation request may include, for example, at least information (for example, identification information) indicating the WL to be allocated (which may be referred to as a “target WL” below).

The management unit 25 performs various kinds of management such as management of a state of allocation of each ACC 4 in the storage housing 3 to WLs, monitoring of usage rates of the ACCs 4, division of calculation resources of the ACCs 4, and the like. The management may include creation and update of each of the pieces of information 21a to 21d. Processing performed by the management unit 25 will be described in description of processing of the temporary allocation unit 26, the allocating unit 27, and the reallocating unit 28.

The temporary allocation unit 26 temporarily allocates the entire calculation resources of an ACC 4 to the target WL in response to the reception of the allocation request, and performs control to transfer the target WL to the ACC 4. Hereinafter, the allocation performed by the temporary allocation unit 26 may be referred to as “temporary allocation”.

For example, the temporary allocation unit 26 provides an instruction to allocate the calculation resources to the target WL to the management unit 25. When the management unit 25 issues an allocation instruction for the storage housing 3 and acquires identification information of the allocatable ACC 4 from the storage housing 3, the management unit 25 updates the WL management information 21a and the ACC management information 21b on the basis of the identification information of the ACC 4.

For example, the management unit 25 registers an entry in which the identification information (WLID) of the target WL is associated with the identification information (ACCID) of the allocatable ACC 4, in the WL management information 21a. In the entry, “temporary allocation” is set as an allocation type, and “-” is set as a PART number.

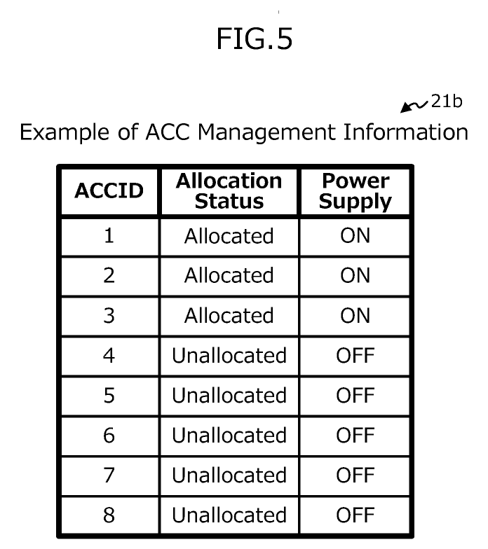

FIG. 5 is a diagram illustrating an example of the ACC management information 21b. The ACC management information 21b is information that records allocation statuses of all the ACCs 4 mounted in the storage housing 3 to WLs. The ACC management information 21b may illustratively include items of ACCID, an allocation status, and a power supply. ACCID is an example of identification information of each ACC 4. The allocation status indicates whether at least some calculation resources of each ACC 4 are allocated to a WL and may include, for example, “allocated” and “unallocated” as setting values. The power supply indicates a power state of the ACC 4, and may include, for example, “ON” and “OFF” as setting values. An ACC 4 with the allocation status of “allocated” and the power supply of “ON” is an example of the ACCs 4a illustrated in FIG. 1. An ACC 4 with the allocation status of “unallocated” and the power supply of “OFF” is an example of the ACCs 4b illustrated in FIG. 1.

For example, the management unit 25 sets “ON” as the power supply and sets “allocated” as the allocation status for an entry of identification information (ACCID) of an allocatable ACC 4 in the ACC management information 21b.

When the update of the information 21a and 21b by the management unit 25 is completed, the temporary allocation unit 26 may notify the data transfer unit 23 of the completion. Thereafter, in a case where the data receiving unit 22 receives the target WL, the data transfer unit 23 refers to the WL management information 21a and transfers the WL to the temporarily allocated ACC 4.

The management unit 25 measures the ACC usage rate (which may be simply referred to as a “usage rate” below) by the target WL after the temporary allocation.

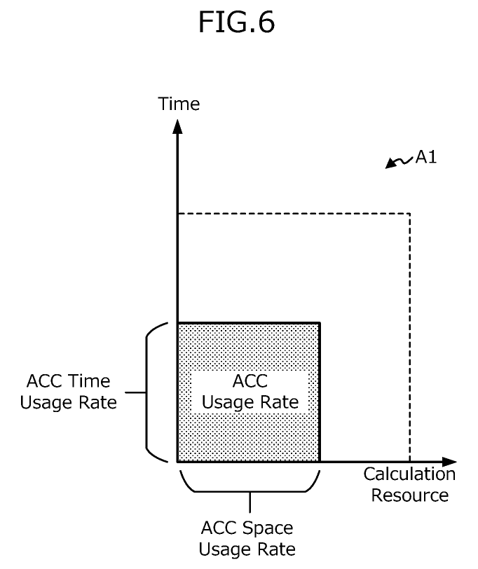

FIG. 6 is a diagram for explaining an example of the ACC usage rate. The reference numeral A1 indicates a graph in which the horizontal axis represents a calculation resource of the ACC 4 and the vertical axis represents time. As illustrated in the graph A1, the ACC usage rate may be calculated by a product (multiplication) of the ACC space usage rate (which may be simply referred to as a “space usage rate” below) and the ACC time usage rate (which may be simply referred to as a “time usage rate” below).

The space usage rate is an example of the calculation resource allocated to the WL, and may be, for example, a ratio of the amount of calculation resource used by the WL at a certain moment with respect to the total amount of calculation resource of the ACC 4. The amount of calculation resource is how large (size) the calculation resource is, and for example, may be represented by a ratio in a case where the entire calculation resource is 1, or may be represented by the number of arithmetic cores or the like. The time usage rate is an example of the usage time of the calculation resource allocated to the WL, and may be, for example, a ratio of the time during which the WL uses the calculation resource per unit time. Note that the time during which the WL uses the calculation resource may include, in addition to the time during which the WL uses the entire calculation resource allocated to the WL, the time during which the WL uses a part of the calculation resource allocated to the WL.

The allocating unit 27 performs control to allocate the target WL to the partition of ACC 4 and transfer the target WL to the partition based on the usage rate measured in the temporary allocation (in other words, the result of temporary allocation). Hereinafter, the allocation performed by the allocating unit 27 may be referred to as “definitive allocation”.

For example, the allocating unit 27 calculates the amount of calculation resource to be definitively allocated to the target WL on the basis of the measured usage rate.

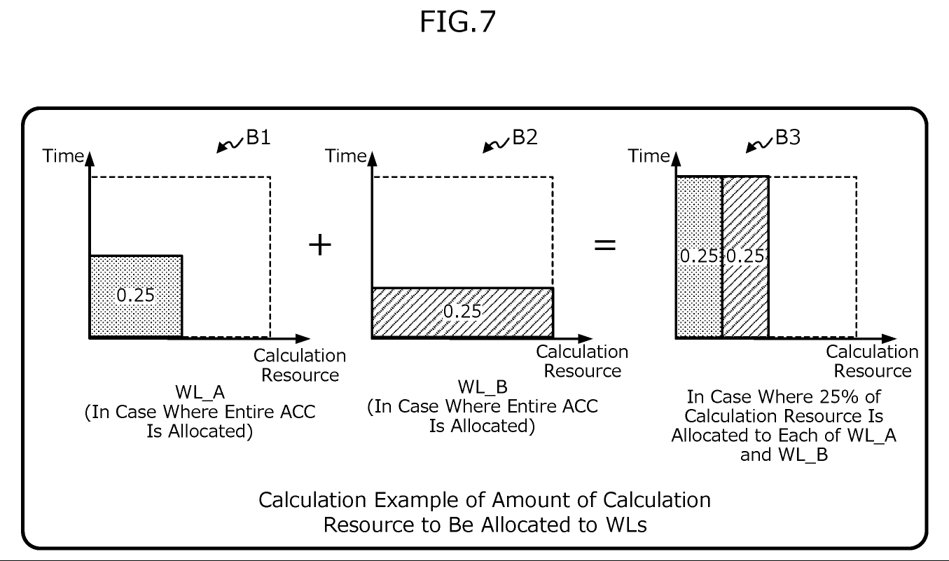

FIG. 7 is a diagram illustrating a calculation example of the amount of calculation resource to be allocated to the WL and illustrates a case where usage rates (space usage rates and time usage rates) have been measured for each of two target WLs (WL_A and WL_B). The reference numeral B1 indicates that the usage rate of a WL_A to which the entire calculation resource of a certain ACC 4 is allocated is 0.25, and reference numeral B2 indicates that the usage rate of a WL_B to which the entire calculation resource of another ACC 4 is allocated is 0.25.

Note that as a result of the entire allocated calculation resource having been used in the WL_B, the space usage rate is 1.0, and the time usage rate is 0.25. On the other hand, as a result of approximately half of the allocated calculation resource having been used in the WL_A, the space usage rate is 0.5, and the time usage rate is 0.5. Such a difference in the ratio between the space usage rate and the time usage rate between the WLs is caused because for example, the numbers of threads used to execute the WLs (correlated with the space usage rates) and the numbers of times the threads have been allocated to the arithmetic cores (correlated with the time usage rates) are different between the WLs. The numbers of threads and the numbers of times of allocation may change depending on various factors such as characteristics (processing schemes) of the WLs and the tendencies of data.

The allocating unit 27 calculates the amount of calculation resource to be allocated to each of the WL_A and the WL_B on the basis of the usage rate of each of the WL_A and the WL_B. For example, the allocating unit 27 may allocate the amount of calculation resource corresponding to each measured usage rate to each of the WL_A and the WL_B. The reference numeral B3 indicates an example in which the allocating unit 27 allocates the amount of calculation resource corresponding to 25% of the calculation resource of the ACC 4 to the WL_A with the usage rate of 0.25, and allocates the amount of calculation resource corresponding to 25% of the calculation resource of the ACC 4 to the WL_B with the usage rate of 0.25.

In the reference numeral B3, for each of the WL_A indicated by the reference numeral B1 and the WL_B indicated by the reference numeral B2, the number of threads correlated to the space usage rate is reduced, and the number of times of allocation correlated to the time usage rate is increased, by reducing the amount of calculation resource to be allocated. In this manner, the time usage rate can be set to 1.0 (100%) by changing the ratio between the space usage rate and the time usage rate while maintaining the usage rate of each of the WL_A and the WL_B at 25%. In this manner, in the case where the target WL is allocated to a partition having the amount of calculation resource of 25%, the ACC usage rate of the partition can be set to 100%.

After the amount of calculation resource is calculated, the allocating unit 27 provides an instruction to allocate the calculation resource to the target WL (for example, allocation of the amount of calculation resource of 25% to each of the WL_A and the WL_B) to the management unit 25. When the management unit 25 issues an allocation instruction for the storage housing 3 and acquires identification information regarding the allocatable ACC 4 from the storage housing 3, the management unit 25 updates the WL management information 21a, the ACC management information 21b, and the PART management information 21c.

Note that in an embodiment, the ACC 4 temporarily allocated to the target WL is assumed to be different from the ACC 4 that is definitively allocated.

For example, the management unit 25 sets “ON” as the power supply and sets “allocated” as the allocation status for an entry of identification information (ACCID) of an allocatable ACC 4 in the ACC management information 21b.

In addition, the management unit 25 creates a partition corresponding to the amount of calculation resource to be allocated to the target WL in the ACC 4.

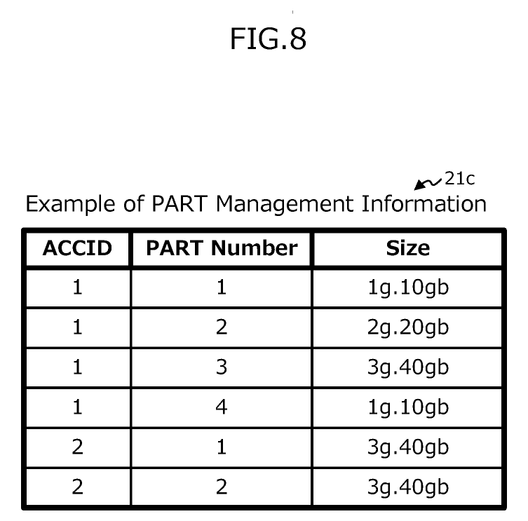

FIG. 8 is a diagram illustrating an example of the PART management information 21c. The PART management information 21c is information that records division statuses of the partitions in the ACCs 4 in the definitive allocation. The PART management information 21c may illustratively include items of ACCID, a PART number, and a size. ACCID is an example of identification information of each ACC 4. The PART number is an example of identification information of each partition. The size is an example of the amount of calculation resource of the partition, and may include, for example, the amount of divided resource of the arithmetic cores and the amount of divided resource of the storage areas of the memory as setting values. In FIG. 8, the size is expressed in a format of “[the amount of divided resource of the arithmetic cores]. (period) [the amount of divided resource of the storage area of the memory]”.

For example, the amount of divided resource of the arithmetic cores may be expressed in the format of m × g (in FIG. 8, 1g, 2g, 3g, or the like) using g as a minimum unit of division. For example, g may be a unit indicating the amount of calculation resource for each one obtained by dividing the calculation resource of the ACC 4 by a predetermined number (M: M is an integer of several to several tens, for example) or may be other units in accordance with various methods. m is an integer of equal to or greater than one and less than M. FIG. 8 illustrates an example in which the amount of calculation resource for each one obtained by dividing the number of arithmetic cores of the ACC 4 with ACCID “1” by 7(M) is defined as g and the divided resource of the arithmetic cores is distributed to each of partitions with PART numbers “1” to “4” such that the total becomes 7g(M × g). Note that the amount of divided resource of the arithmetic cores may be expressed by another method, for example, a range or the like of the identification numbers of the arithmetic cores in the ACC 4.

As the amount of divided resource of the storage areas of the memory, for example, the size of the storage areas allocated to the partition may be expressed by a numerical value (the unit is giga byte (gb)). FIG. 8 illustrates an example in which the size of the storage areas of the memory for the ACC 4 with the ACCID “1” is 80 gb (GB), and the divided resource of the storage areas is divided to each of the partitions with PART numbers “1” to “4” such that the total becomes 80 gb. Note that the amount of divided resource of the storage areas may be expressed by other various methods. Although FIG. 8 illustrates an example in which the amount of divided resource of the storage areas of the memory is set as a fixed numerical value according to the amount of divided resource of the arithmetic cores, the present disclosure is not limited thereto.

The management unit 25 creates a partition having the smallest size among partitions satisfying the condition of the size (for example, the ratio of 25%) indicated by the instruction from the allocating unit 27, in the ACC 4 with ACCID acquired from the storage housing 3. For example, in a case where target WLs are the WL_A and the WL_B, and the amount of calculation resource corresponding to 25% is allocated to each target WL, the management unit 25 may determine to create two partitions with the size of “2g.20gb” (in a case where M = 7, g corresponds to 14.3%). Then, the management unit 25 creates partitions in the ACC 4 according to the determined size. For example, the management unit 25 may provide an instruction to create the partitions to the storage housing 3.

The management unit 25 sets information (ACCID, PART numbers, the size) regarding the partitions created through the above processing in the PART management information 21c.

In addition, the management unit 25 updates the entry of the target WLs registered as belonging to the allocation type “temporarily allocated” in the WL management information 21a. For example, the management unit 25 sets (updates) the identification information of the ACC 4 allocated by the definitive allocation in the ACCID in the entry, and sets (updates) the PART numbers of the created partitions in the PART numbers.

The allocating unit 27 provides, to the management unit 25, an instruction to move (transfer) the target WLs from the ACC 4 of the temporary allocation to the partitions of the ACC 4 of the definitive allocation and return the ACC 4 of the temporary allocation. The management unit 25 issues a return instruction for the storage housing 3 in response to the return instruction.

The allocating unit 27 may notify the data transfer unit 23 of the change in the allocation of the target WLs. The notification may include the ACCID and the partition numbers definitively allocated to the target WLs. Thereafter, in a case where the data receiving unit 22 receives the target WLs, the data transfer unit 23 refers to the WL management information 21a and transfers the WLs to the partitions of the definitively allocated ACC 4.

Incidentally, there may be a case where a pattern in which the calculation resource can be divided has been determined in the ACC 4. In the above-described example, the amount of divided resource of the arithmetic cores is determined to be any of patterns of m × g (1 ≤ m < M) with g regarded as a minimum unit as illustrated in FIG. 8. Therefore, the size of the partition allocated to the WL is rounded up to the smallest size among the sizes satisfying the amount of calculation resource (a requirement of the usage rate of the WL) calculated by the allocating unit 27.

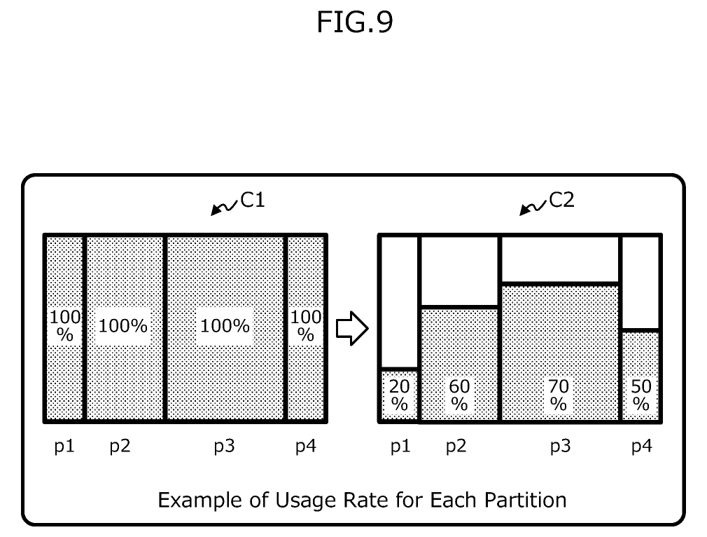

FIG. 9 is a diagram illustrating an example of the usage rate for each partition. Reference numerals C1 and C2 indicate examples of the usage rates (which may be referred to as “PART usage rates” below) of the calculation resource that each partition has in a case where the horizontal axis represents partitions (four partitions p1, p2, p3, and p4) and the vertical axis represents the ACC usage rate. The reference numeral C1 indicates, as a comparative example, a PART usage rate in a case where both the amount of calculation resource of each of the partitions p1 to p4 and the amount of calculation resource of each WL calculated by the allocating unit 27 are the same.

As illustrated by the reference numeral C2, in a case where the sizes of the partitions p1 to p4 allocated to the WLs are rounded up to the smallest size among the sizes satisfying the requirement of the usage rate of the WLs, more calculation resource is allocated to each WL, and the PART usage rate thus becomes less than 100%.

Here, as described above, there may be a case where the ACC 4 is designed to have the highest power efficiency (for example, performance per power consumption, for example, frames per second (fps)/Watt (W)) when it is running at its full capacity. The expression “when it is running at its full capacity” refers to, for example, a state where the usage rate is around 100% and both the time usage rate and the space usage rate are around 100%. In addition, the ACC 4 may have a function of enabling reduction of power consumption of the ACC 4 in a case where the operation frequency of the arithmetic cores decreases. Furthermore, in an embodiment, it is assumed that WL data, for example, stream data, has a fixed performance requirement (for example, a constant frame rate, a constant frame size, or the like).

On the basis of the above premise, the reallocating unit 28 changes (lowers, for example) the operation frequency of the ACC 4 such that each PART usage rate becomes a predetermined value (for example, equal to or greater than 90 to 95%, preferably 100%; the same applies to the following description) within a range in which the WL performance requirement is satisfied after the definitive allocation by the allocating unit 27. The decrease in operation frequency of the ACC 4 leads to an increase in time usage rate in each partition (which approaches 100%, for example). As a result, it is possible to reduce power consumption by setting the PART usage rate to a predetermined value while suppressing degradation of performance and to thereby improve power efficiency of the ACC.

Note that since the operation frequency is changed in units of ACCs 4, the change may affect the PART usage rates of all the partitions in the same ACC 4. Therefore, the reallocating unit 28 changes the operation frequency after controlling the allocation of WLs and ACCs 4 such that a set of WLs having close (for example, similar) PART usage rates is allocated to the same ACC 4. Hereinafter, the allocation performed by the reallocating unit 28 may be referred to as “reallocation”.

For example, the reallocating unit 28 groups a plurality of WLs executed in a plurality of first ACCs 4 according to the usage rate of the calculation resource of the partition to which each of the WLs has been allocated. In addition, the reallocating unit 28 moves the plurality of WLs included in the group to second ACCs 4 associated with the group, for each grouped group. Then, the reallocating unit 28 lowers the operation frequency of each of the plurality of second ACCs 4.

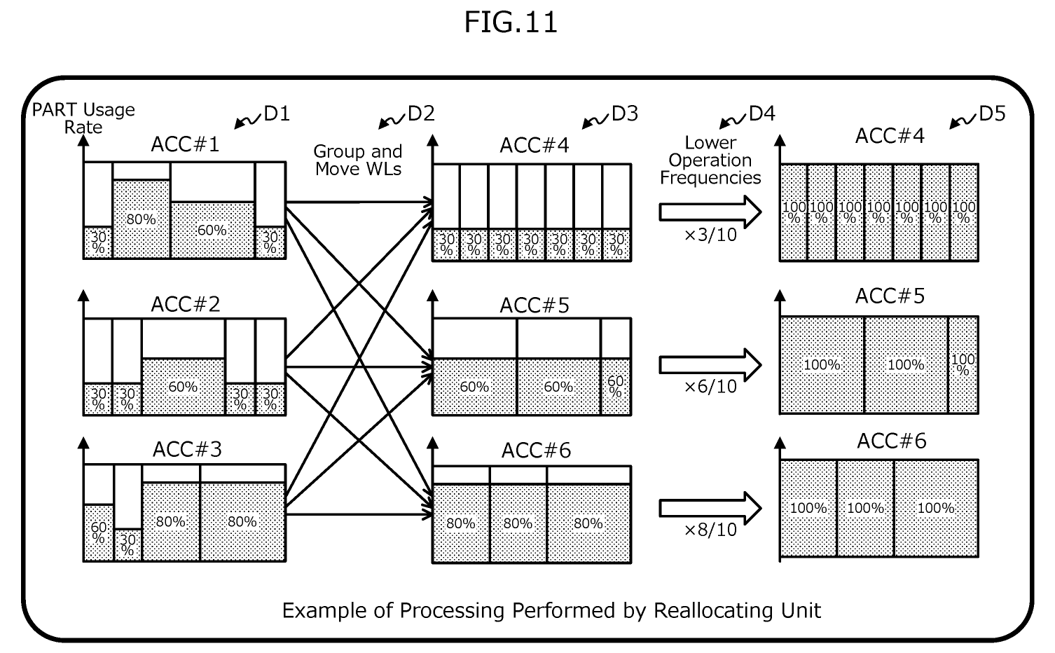

FIG. 11 is a diagram for explaining an example of processing performed by a reallocating unit 28. Hereinafter, the example of the processing performed by the reallocating unit 28 will be described with reference to FIG. 11. Note that the reallocating unit 28 may be activated at a predetermined timing (for example, periodically) to execute the reallocation processing.

The reallocating unit 28 selects a set (ACC set) of ACCs 4 operating at a given (e.g., default) operation frequency and performing a WL which has been definitively allocated, and determines whether there are the same number of ACCs 4b in an unallocated state as the number of ACCs 4 in the ACC set. Hereinafter, the ACCs 4 in the selected ACC set will be referred to as first ACCs 4. The plurality of first ACCs 4 are an example of the plurality of first accelerators.

Note that the reallocating unit 28 may inquire of the management unit 25 about the number of ACCs 4 with the allocation status “unallocated” in the ACC management information 21b, for example. In a case where there are not the same number of unallocated ACCs 4b as the number of ACCs in the ACC set, the reallocating unit 28 may end the processing.

In a case where the same number of unallocated ACCs 4b as the number of ACCs in the ACC set are present, the reallocating unit 28 measures the PART usage rate in each of the first ACCs 4 in the ACC set and creates the PART usage rate information 21d. Note that the reallocating unit 28 may omit measurement of the usage rates of the ACC 4 that are temporarily allocated. The creation of the PART usage rate information 21d may be performed by the management unit 25.

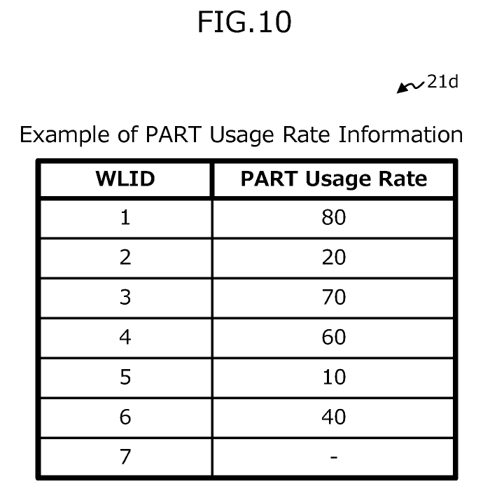

FIG. 10 is a diagram illustrating an example of the PART usage rate information 21d. The PART usage rate information 21d is information that records the PART usage rates of the first ACCs 4 operating at the given operation frequency among the ACCs 4 that are definitively allocated to each WL. The PART usage rate information 21d may illustratively include items of WLID and the PART usage rate. WLID is an example of identification information of each WL. The PART usage rate is an example of the usage rate of the calculation resource that each partition to which the WL is allocated has and may be calculated by a product (multiplication) between the space usage rate of the calculation resource that the partition has and the time usage rate of the calculation resource that the partition has. For example, the PART usage rate may be calculated from an average or a weighted average of measured values for a certain period of time, or may be calculated from measured values at a certain time point. Note that each partition is set such that the space usage rate of the allocated WL becomes 100% (approaches 100% as close as possible) in the definitive allocation. For a certain WL, the space usage rate of the partition allocated in the definitive allocation and the space usage rate of the partition allocated in the reallocation do not change (are constant). Therefore, the PART usage rate set in the PART usage rate information 21d can be regarded as being substantially the time usage rate of the partition.

The reference numeral D1 in FIG. 11 indicates an example of the PART usage rates of each of three first ACCs 4, namely ACCs #1, #2, and #3. As with the reference numeral C2 in FIG. 9, the shaded rectangular frame indicates the PART usage rate of each of the plurality of partitions included in each first ACC 4. Note that the numerical value (%) of the PART usage rate is indicated in each rectangular frame.

The reallocating unit 28 groups a plurality of WLs (which may be referred to as a “WL group below”) recorded in the PART usage rate information 21d according to the PART usage rates as indicated as “grouped” by the reference numeral D2. As an example of a grouping algorithm, there is a method in which the PART usage rates are sorted and WLs are added to the group in order from the WLs with low PART usage rates from the sorting result. In this method, the reallocating unit 28 sets all the WLs added to the group as belonging to one group when the total amount of calculation resources allocated to the WLs added to the group (the total size of the partitions because this is definitive allocation) reaches the amount of calculation resource of one ACC 4. The reallocating unit 28 repeats the processing according to the algorithm until the sizes of the amounts of calculation resources of all the groups have reached the amount of calculation resource of one ACC 4.

In the example of FIG. 11, seven partitions with a PART usage rate of 30% are added to a first group, three partitions with a PART usage rate of 60% are added to a second group, and three partitions with a PART usage rate of 80% are added to a third group through the grouping.

Since the size of the partitions is an integer multiple of g, there is a possibility that the total of the amounts of calculation resources of WLs added to each group does not reach the amount of calculation resource of one ACC 4 through the grouping in accordance with the above-described algorithm. In this case, the reallocating unit 28 may delete, from the ACC set, a first ACC 4 having a high (for example, the highest) ACC usage rate among the plurality of first ACCs 4 selected as the ACC set, and may perform grouping on the ACC set after the deletion according to the above-described algorithm. Alternatively, the reallocating unit 28 may end the reallocation processing in this case.

The grouping algorithm is not limited to the above-described method. For example, various algorithms such as a classification algorithm that reduces variance of the PART usage rates of the WLs in the group may be used in all the groups after the grouping.

When the grouping is completed, the reallocating unit 28 provides an instruction to allocate the same number of ACCs 4 as the number of groups and create partitions in accordance with the amount of calculation resource of the WLs in the groups. The instruction may include identification information of the WLs included in each of the plurality of groups. When the management unit 25 issues an allocation instruction for the storage housing 3 and acquires identification information regarding a plurality of allocatable ACCs 4 from the storage housing 3, the management unit 25 updates the WL management information 21a, the ACC management information 21b, and the PART management information 21c. Hereinafter, the allocatable ACCs 4 will be referred to as second ACCs 4. The second ACCs 4 are an example of the second accelerators. The reference numeral D3 in FIG. 11 indicates three second ACCs 4, namely ACCs #4, #5, and #6. Note that in an embodiment, it is assumed that the first ACCs 4 and the second ACCs 4 are mutually different ACCs 4.

For example, the management unit 25 sets “ON” for the power supply and sets “allocated” for the allocation status for each of entries of identification information (ACCID) of the plurality of second ACCs 4 in the ACC management information 21b.

In addition, the management unit 25 associates the plurality of second ACCs 4 with the plurality of groups on a one-to-one basis. In the example of FIG. 11, a first group is associated with the ACC #4, a second group is associated with the ACC #5, and a third group is associated with the ACC #6. Then, the management unit 25 creates, for each group, a plurality of partitions in the second ACC 4 associated with the group in accordance with the amount of calculation resource allocated to each of the plurality of WLs included in the group.

The management unit 25 sets information (ACCID, PART numbers, the size) regarding the partitions created through the above processing in the PART management information 21c.

In addition, the management unit 25 updates the plurality of entries of the WL group registered as belonging to the allocation type “definitive allocation” in the WL management information 21a. For example, the management unit 25 sets (updates) the identification information of the second ACCs 4 allocated by the reallocation in the ACCID in each of the plurality of entries, and sets (updates) the PART numbers of the created partitions in the PART numbers.

The reallocating unit 28 provides, to the management unit 25, an instruction to move (transfer) each of the plurality of WLs from the definitively allocated first ACCs 4 to the partitions of the reallocated second ACCs 4 as indicated by “move” of the reference numeral D2 and return the first ACCs 4. The management unit 25 issues a return instruction for the storage housing 3 in response to the return instruction.

The reallocating unit 28 may notify the data transfer unit 23 of the change in the allocation of the plurality of WLs. The notification may include the ACCIDs and the partition numbers reallocated to the plurality of WLs. Thereafter, in a case where the data receiving unit 22 receives these WLs, the data transfer unit 23 refers to the WL management information 21a and transfers the WLs to the partitions of the reallocated ACCs 4. Accordingly, as indicated by the reference numeral D3, the ACC #4 associated with the first group (PART usage rate: 30%), the ACC #5 associated with the second group (PART usage rate: 60%), and the ACC #6 associated with the third group (PART usage rate: 80%) execute the WLs instead of the ACCs #1, #2, and #3.

As indicated by the reference numeral D4, the reallocating unit 28 lowers the operation frequency of each of the plurality of second ACCs 4 after the transition (or with the transition) of the WLs from the definitive allocation to the reallocation. For example, the reallocating unit 28 may set, for each of the second ACCs 4, the operation frequency so that the PART usage rate of a WL having a high (for example, the highest) PART usage rate among the plurality of WLs to be executed in the second ACC 4 becomes a predetermined value. As an example, the reallocating unit 28 may multiply the operation frequency of the second ACC 4 by, for example, the highest PART usage rate among the WLs to be executed in the second ACC 4.

In the example of FIG. 11, the reallocating unit 28 multiplies the operation frequency of the ACC #4 in which the PART usage rate of each WL is 30% (0.3) by 3/10 (multiplies it by 0.3). Also, the reallocating unit 28 multiplies the operation frequency of the ACC #5 in which the PART usage rate of each WL is 60% (0.6) by 6/10 (multiplies it by 0.6). Furthermore, the reallocating unit 28 multiplies the operation frequency of the ACC #6 in which the PART usage rate of each WL is 80% (0.8) by 8/10 (multiplies it by 0.8).

Accordingly, it is possible to lower the operation frequency of each of the ACCs #4, #5, and #6 as indicated by the reference numeral D5 and along with this, it is possible to set the PART usage rates of all the WLs to 100%.

Note that when the reallocation processing is completed, the reallocating unit 28 may delete the PART usage rate information 21d.

As described above, according to the reallocating unit 28, the WL groups operating in the ACC set (the plurality of first ACCs 4) are grouped by changing combinations of the WLs to be allocated to the same ACCs 4, and then each group is moved to the second ACCs 4 that are different from each other. In other words, the reallocating unit 28 aggregates a plurality of WLs having the same (similar) PART usage rates into a single second ACC 4. Then, the reallocating unit 28 lowers the operation frequency of each of the plurality of second ACCs 4 and thereby increases the PART usage rates. As a result, the power consumption of the second ACCs 4 can be reduced. Therefore, power efficiency indicating performance per power consumption can be improved.

In the grouping processing, the plurality of groups is created such that WLs having close PART usage rates (time usage rates) are included in each of the plurality of groups. As a result, the PART usage rates of all the WLs in each group can be caused to approach a predetermined value as a whole (see, for example, the reference numeral D4 in FIG. 11) when the operation frequencies of the second ACCs 4 are lowered, and power consumption of the second ACCs 4 can be reduced more effectively.

Furthermore, in the processing of lowering the operation frequencies, the operation frequencies of the second ACCs 4 are lowered within a range in which performance requirements of each of the plurality of WLs to be executed in the second ACCs 4 are satisfied, for each second ACC 4. As a result, it is possible to suppress degradation of performance of the WLs due to the reallocation processing and to thereby further improve power efficiency indicating the performance per power consumption.

In the reallocation processing, when the WLs are moved to the second ACCs 4, partitions having a size corresponding to the amounts of calculation resources of the WLs are created in the second ACCs 4, and the WLs are moved to the partitions. As a result, since the WLs can be moved to the second ACCs 4 in a state where the PART usage rates measured in the first ACCs 4 are maintained to some extent (for example, see the reference numeral D3 in FIG. 11), the power consumption of the second ACCs 4 can be reduced more effectively.

Furthermore, the number of groups created in the grouping processing is the same as the number of the plurality of first ACCs 4. As a result, it is possible to keep the number of ACCs 4 to be used to execute the WLs constant before and after the reallocation processing and to lower the operation frequency of each of the second ACCs 4. Therefore, the power consumption can be reduced in the entire system 1.

### [B] Operation Example

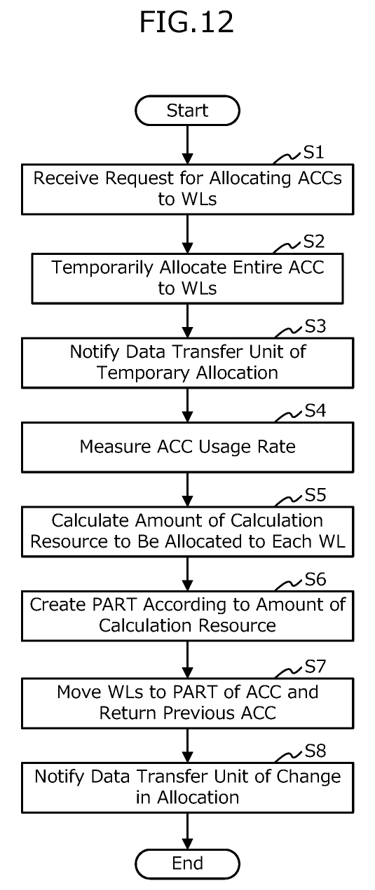

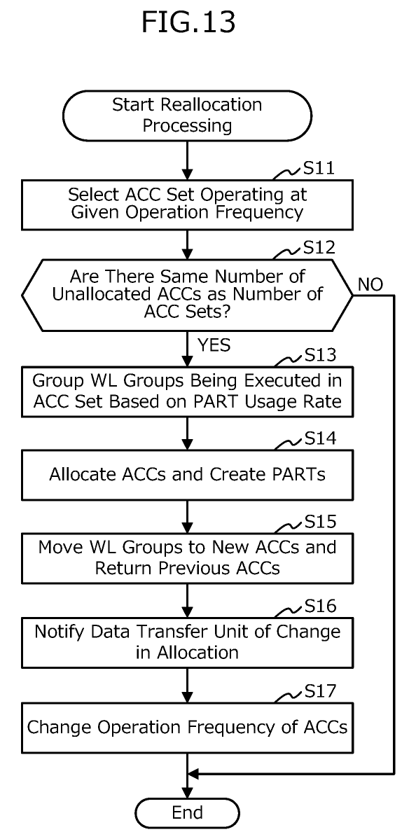

Next, an operation example of the system 1 (for example, the server 2) according to an embodiment will be described. FIG. 12 is a flowchart for explaining an operation example of the system 1 according to an embodiment, and FIG. 13 is a flowchart for explaining an operation example of the reallocation processing according to an embodiment. Note that, hereinafter, description of the update processing of a part of information performed by the management unit 25 will be omitted.

As illustrated as an example in FIG. 12, the allocation request receiving unit 24 of the server 2 receives a request for allocating the ACCs 4 to each of one or more target WLs from the client 6 (Step S1).

The temporary allocation unit 26 temporarily allocates an entire ACC 4 to each of the target WLs in cooperation with the management unit 25 (Step S2) and notifies the data transfer unit 23 of the temporary allocation (Step S3). The data transfer unit 23 transfers each target WL to each temporarily allocated ACC 4 on the basis of the WL management information 21a updated by the management unit 25. The management unit 25 measures the usage rate (ACC usage rate) of each temporarily allocated ACC 4 (Step S4).

The allocating unit 27 calculates the amount of calculation resource to be allocated to each target WL on the basis of the result of measuring the usage rate (Step S5). The allocating unit 27 creates partitions in each ACC 4 in accordance with the calculated amount of calculation resource in cooperation with the management unit 25 (Step S6), moves each target WL to each partition, and returns the ACC 4 (previous ACC 4) temporarily allocated to each target WL (Step S7). In addition, the allocating unit 27 notifies the data transfer unit 23 of the definitive allocation (the change in allocation) (Step S8) and ends the processing.

After the definitive allocation is performed, the server 2 (control unit 20) periodically activates the reallocating unit 28. The reallocating unit 28 executes the reallocation processing (see FIG. 13).

As illustrated as an example in FIG. 13, the reallocating unit 28 selects the ACC set of the first ACCs 4 operating at the given operation frequency (Step S11) and determines whether there are the same number of unallocated ACCs 4 as the number of ACCs in the ACC set (Step S12). In a case where there are not the same number of unallocated ACCs 4 as the number of ACCs in the ACC set (NO in Step S12), the reallocation processing is ended.

In a case where there are the same number of unallocated ACC 4 (second ACCs 4) as the number of ACCs in the ACC set (YES in Step S12), the reallocating unit 28 measures the PART usage rate for each partition in the ACC set, and groups the WL groups being executed in the ACC set on the basis of the PART usage rates (Step S13). The reallocating unit 28 allocates the second ACCs 4 to each of the groups in cooperation with the management unit 25, and creates partitions in the second ACCs 4 according to the amounts of calculation resources of the WL in the group (Step S14).

For each group, the reallocating unit 28 moves the WLs in the group to the partitions of the corresponding second ACCs 4, and returns the first ACCs 4 (previous ACCs 4) definitively allocated to each WL (Step S15). In addition, the reallocating unit 28 notifies the data transfer unit 23 of the reallocation (the change in allocation) (Step S16).

The reallocating unit 28 changes (decreases) the operation frequencies of the second ACCs 4 according to the PART usage rates of the WLs operating in the second ACCs 4 (Step S17) and ends the reallocation processing.

### [C] Others

The technique according to the above-described embodiments can be modified, changed, and implemented as follows.

For example, the functional blocks 20, 20a, 20b, and 21 to 28 included in the server 2 illustrated in FIG. 3 may be integrated in arbitrary combinations, or each of them may be divided. Also, the information 21a, 21b, 21c, and 21d stored in the memory unit 21 illustrated in FIG. 3 may be integrated in arbitrary combinations, or each of them may be divided.

In the embodiment, the management unit 25 allocates the first ACCs 4 that are different from those in the temporary allocation to the target WLs in the definitive allocation, and the reallocating unit 28 allocates the second ACCs 4 that are different from those in the definitive allocation to the groups (WLs) in the reallocation. This is to shorten (for example, minimize) an interruption time during which execution of the WLs is interrupted at the time of transition from the temporary allocation to the definitive allocation or transition from the definitive allocation to the reallocation (which will be collectively and simply referred to as “transition” below).

For example, in a case where the same ACCs 4 are used before and after the transition, the processing of the WLs sequentially input as stream data may be interrupted during the creation time for creating partitions in the ACCs 4. Depending on the ACCs 4, the creation time may be about several tens of seconds to several minutes, for example. Therefore, mutually different ACCs 4 are used before and after the transition in order to shorten the interruption time in an embodiment.

Note that the same ACCs 4 may be used before and after the transition in a case where the interruption time is allowable or occurrence of interruption can be suppressed depending on WLs, specifications of the ACCs 4, and other factors. In other words, one or more first ACCs 4 and one or more second ACCs 4 may be shared (same) in the reallocation.

Although the method of adding WLs to the groups in order from a WL with a low PART usage rate among sorted WL groups in the grouping processing by the reallocating unit 28 has been described in the embodiment, the present disclosure is not limited thereto. For example, the reallocating unit 28 may add the WLs to the groups in descending order of the PART usage rates from among the sorted WL groups, or may set the range of the PART usage rate for each group according to distribution of the PART usage rates of the WL groups and add the WLs to the groups in which the corresponding range has been set in order not depending on the levels of the PART usage rates.

Furthermore, although the description has been given assuming that the reallocating unit 28 lowers the operation frequencies of the second ACCs 4 after the reallocation (after the execution of the WLs in the second ACCs 4 is started) in the embodiment, the present disclosure is not limited thereto. The lowering of the operation frequencies of the second ACCs 4 may be performed in parallel with the reallocation processing, for example, as long as the groups have already been associated with the second ACCs 4.

For example, the reallocating unit 28 may measure the PART usage rate of each partition for the second ACCs 4 operating at the reduced operating frequencies at regular time intervals. In a case where presence of partitions with the PART usage rates of less than a predetermined value is detected in the plurality of second ACCs 4 as a result of the measurement, the reallocating unit 28 may add the detected second ACCs 4 to the first ACCs 4 to be subjected to the next reallocation processing. For example, the reallocating unit 28 may treat the detected second ACCs 4 as the first ACCs 4 to be subjected to the reallocation processing by changing (increasing) the operation frequencies of the detected second ACCs 4 to a given value. Alternatively, the reallocating unit 28 may mark the detected second ACCs 4 as ACCs 4 to be subjected to the reallocation processing in management information such as the ACC management information 21b. As a result, it is possible to reduce power consumption while flexibly addressing variations in WLs.

According to an aspect, the present embodiments can reduce power consumption of the accelerators.

Throughout the descriptions, the indefinite article “a” or “an”, or adjective “one” does not exclude a plurality.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A non-transitory computer-readable recording medium having stored therein an operation frequency changing program that causes a computer to execute a changing process comprising:
grouping a plurality of processes to be executed by a plurality of first accelerators in accordance with usage rates of calculation resources that partitions to which each process has been allocated have;
for each of grouped groups, moving a plurality of processes included in the group to a second accelerator associated with the group; and
lowering an operation frequency of each of a plurality of the second accelerators.

2. The non-transitory computer-readable recording medium according to claim 1,
wherein the grouping comprises creating a plurality of the groups such that processes with similar time usage rates of the calculation resources are included in each of the plurality of groups.

3. The non-transitory computer-readable recording medium according to claim 1,
wherein the lowering comprises, for each of the second accelerators, lowering an operation frequency of the second accelerator within a range in which performance requirements of each of a plurality of processes to be executed by the second accelerator are satisfied.

4. The non-transitory computer-readable recording medium according to claim 1,
wherein the moving comprises, for each of the grouped groups,
for each of a plurality of processes included in the group, creating partitions that have calculation resources in accordance with an amount of calculation resources to be used for the process in the second accelerators associated with the group, and
moving each of the plurality of processes included in the group to the plurality of created partitions.

5. The non-transitory computer-readable recording medium according to claim 1,
wherein the grouping comprises creating the same number of the groups as a number of the plurality of first accelerators.

6. A computer-implemented operation frequency changing method executed by a computer, the method comprising:
grouping a plurality of processes to be executed by a plurality of first accelerators in accordance with usage rates of calculation resources that partitions to which each process has been allocated have;
for each of grouped groups, moving a plurality of processes included in the group to a second accelerator associated with the group; and
lowering an operation frequency of each of a plurality of the second accelerators.

7. The computer-implemented operation frequency changing method according to claim 6,
wherein the grouping comprises creating a plurality of the groups such that processes with similar time usage rates of the calculation resources are included in each of the plurality of groups.

8. The computer-implemented operation frequency changing method according to claim 6,
wherein the lowering comprises, for each of the second accelerators, lowering an operation frequency of the second accelerator within a range in which performance requirements of each of a plurality of processes to be executed by the second accelerator are satisfied.

9. The computer-implemented operation frequency changing method according to claim 6,
wherein the moving comprises, for each of the grouped groups,
for each of a plurality of processes included in the group, creating partitions that have calculation resources in accordance with an amount of calculation resources to be used for the process in the second accelerators associated with the group, and
moving each of the plurality of processes included in the group to the plurality of created partitions.

10. The computer-implemented operation frequency changing method according to claim 6,
wherein the grouping comprises creating the same number of the groups as a number of the plurality of first accelerators.

11. An information processing apparatus comprising:
a memory; and
a processor coupled to the memory, the processor being configured to perform a changing process comprising
grouping a plurality of processes to be executed by a plurality of first accelerators in accordance with usage rates of calculation resources that partitions to which each process has been allocated have,
for each of grouped groups, moving a plurality of processes included in the group to a second accelerator associated with the group, and
lowering an operation frequency of each of a plurality of the second accelerators.

12. The information processing apparatus according to claim 11,
wherein processor creates a plurality of the groups such that in the grouping, processes with similar time usage rates of the calculation resources are included in each of the plurality of groups.

13. The information processing apparatus according to claim 11,
wherein in the lowering, the processor lowers, for each of the second accelerators, an operation frequency of the second accelerator within a range in which performance requirements of each of a plurality of processes to be executed by the second accelerator are satisfied.

14. The information processing apparatus according to claim 11,
wherein in the moving, and for each of the grouped groups, the processor
creates, for each of a plurality of processes included in the group, partitions that have calculation resources in accordance with an amount of calculation resources to be used for the process in the second accelerators associated with the group, and
moves each of the plurality of processes included in the group to the plurality of created partitions.

15. The information processing apparatus according to claim 11,
wherein in the grouping, the processor creates the same number of the groups as a number of the plurality of first accelerators.
